(19) United States
(12) Patent Application Publication
(10) Pub. No.: US 2002/0070708 A1
(43) Pub. Date: Jun. 13, 2002

(54) BATTERY CHARGING DEVICE

(76) Inventor: Ten-Der Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/732,303

(22) Filed: Dec. 8, 2000

(51) Int. Cl. H02J 7/00

(52) U.S. Cl. 320/134

(57) ABSTRACT

A digital battery charging device comprises a digital switch power supply circuit, a first control circuit, a second control circuit, a third control circuit, two control switches, a battery and an engine automatic rotation motor. The digital battery charging device charges the battery in a constant current or a smaller current in a constant voltage until achieve a voltage of being full charged. The first control circuit has a charger conduction time period control circuit. The battery is charged in a conduction time period. At the distal end of non-conduction, it detect the voltage of the battery. If the voltage has achieved a selected preset value, then power of the charger is cut off. Otherwise, the next charging period proceeds. These two functions operate at the same time for controlling the safety and efficiency of the charger charging the battery.

### FIELD OF THE INVENTION

The present invention is pertinent to a digital battery charging device, and especially to charger for preventing the danger of overcharging a battery and the battery can be charged in a high efficiency.

### BACKGROUND OF THE INVENTION

Referring to FIG. 1, a block diagram of charging a prior art battery is illustrated. In that process, the voltage of an input A. C. power is reduced through a transformer 60 and then the current is rectified through a diode 65 for charging a battery. Since the filter capacitor must be enlarged. Under the consideration of cost, it has no function of filtering.

Since the charging is executed in a constant voltage. The efficiency is easily effected due to the charging of the battery and aged. For a long period of charging, the battery will be heated so that gas is vented out to induce an explosion.

Besides, the A. C. current is varied due to the battery and the amount of outer A. C. power source. Since a large ripple occurs, the charging efficiency is bad and it is hard to control it.

Furthermore, the detected control voltage is a working voltage of the charger and battery, the A. C. current will become smaller due to the aging of the battery. Moreover, the variation of the A. C. power source will induce the instability of the charging control function.

Further, as the charger is in contact with a battery, a large spark occurs. If the battery is short-circuited, the charger will consume a large current in charging so that a danger induce. Or an inverse polarity contact occurs, it can not cut off current transiently although a metal switch is used as a protection.

Alternatively, the prior art charger can not assist a large current to a car engine many times. It must further use a large transformer and thus the cost is very high.

### SUMMARY OF THE INVENTION

Accordingly, the primary object of the present invention is to provide a digital switch power supply circuit, wherein a digital battery charging device charges the battery in a constant current or a smaller current in a constant voltage until achieve a voltage of being full charged. The first control circuit has a charger conduction time period control circuit. The battery is charged in a conduction time period. At the distal end of non-conduction, it detects the voltage of the battery. If the voltage has achieved a selected preset value, then power of the charger is cut off. Otherwise, the next charging period proceeds. These two functions operates at the same time for controlling the safety and efficiency of the charger charging the battery.

Another object of the present invention is to provide a digital battery charging device which is formed by a full function control circuit and a digital switch power source. Since it is outputted by a switching power rectifying and thus it has the advantages of stable charging voltage and current (no ripple occurs from rectifying), high efficiency, small volume and light-weight.

A further object of the present invention is to provide a digital battery charging device, wherein the charging period is divided into a charging conduction time period and a non-conduction time period. Therefore, the battery will not be charged overlong so as to induce a large amount of heat and gas reaction in the battery which will induce an explosion. When it is not conducted in the charging conductive period, the voltage of the battery is detected for measuring a real voltage of the battery.

A yet object of the present invention is to provide a digital battery charging device, wherein a control circuit is formed by a battery voltage detecting circuit; a charger output conduction control circuit, an inverse polarity protecting circuit, an automatic control circuit and an actuating switch. The spark does not occur as the charger is in contact with the battery.

A still object of the present invention is to provide a digital battery charging device, wherein the charger is used as an auxiliary power source as an engine is actuated and used repeatedly and many times for assisting a large current to the car engine.

The various objects and advantages of the present invention will be more readily understood from the following detailed description when read in conjunction with the appended drawing.

### BRIEF DESCRIPTION OF THE DRAWINGS

FIG. 1 is a functional block diagram of a prior art battery charger.

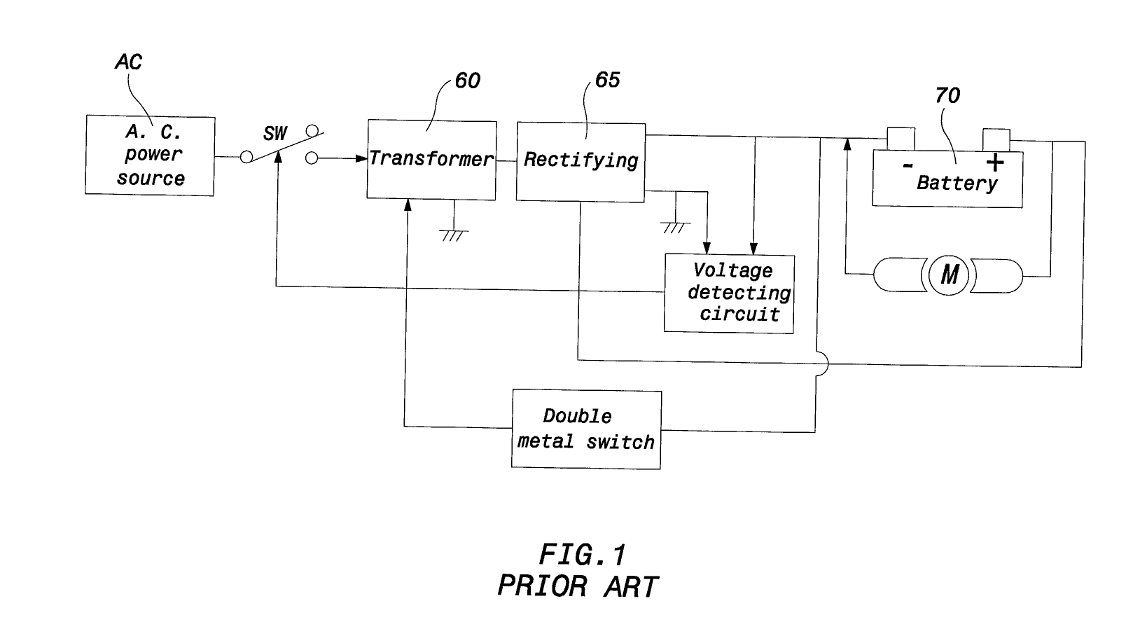

FIG. 2 is a circuit block diagram of the present invention.

FIG. 3 is a circuit block diagram of another embodiment of the present invention.

### DETAILED DESCRIPTION OF THE PREFERRED EMBODIMENTS

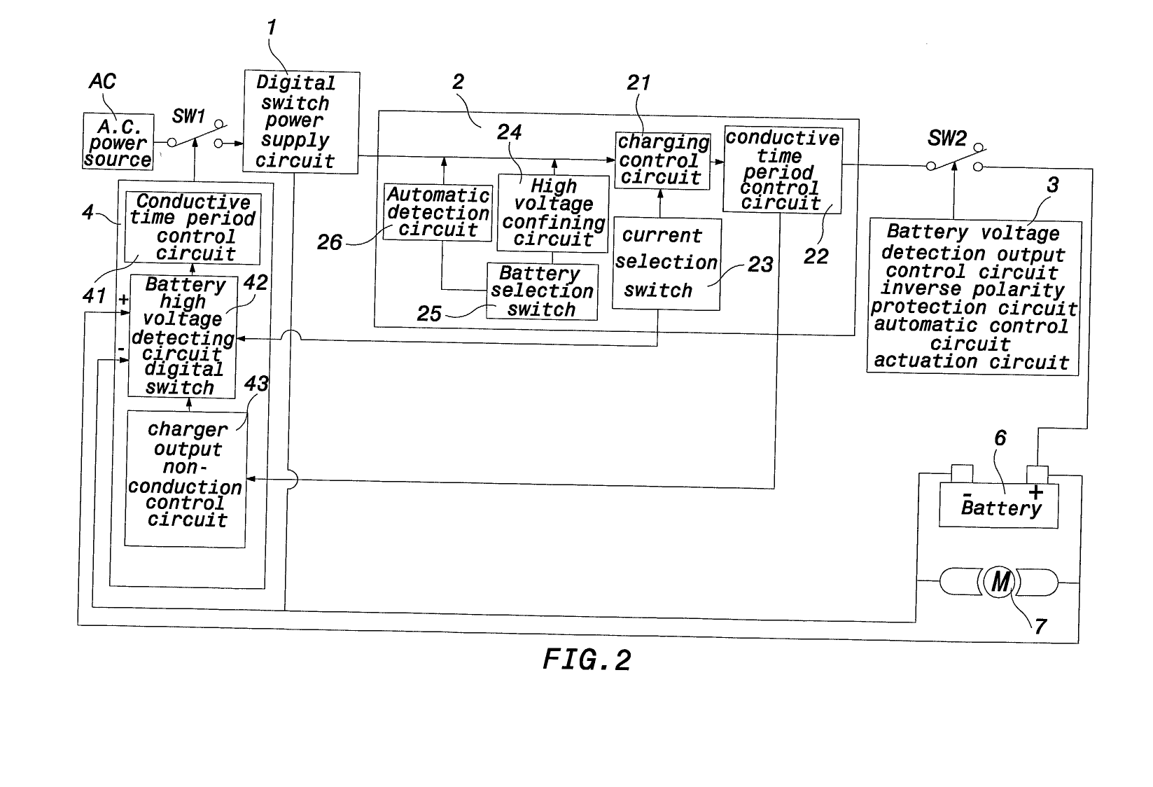

Referring to FIG. 2, the digital battery charging device of the present invention is illustrated. The digital battery charging device includes a digital switch power supply circuit 1, a first control circuit 2, a second control circuit 3, a third control circuit 4, two control switches SW1, SW2, a battery 6, an engine automatic rotation motor 7, etc.

The digital switch power supply circuit 1 is connected to an A. C. power supply AC through a first control switch SW1. The digital switch power supply circuit 1 is conducted through a first control switch SW1 so as to convert the input A. C. power into digital D. C. power to be outputted for supplying working power of all elements.

The first control circuit 2 is installed with a charging control circuit 21. The charging control circuit 21 has an input connected to the digital switch power supply circuit 1. The output of the charging control circuit 21 is connected to a conductive time period control circuit 22. The output of the conductive time period control circuit 22 is connected to the battery 6 through the second control switch SW2. The positive and negative polarities of the battery 6 are connected to the engine automatic rotation motor 7. The charging control circuit 21 is connected to a current selection switch 23 which is used to adjust and select the amount of the current flow, such as 2 amperes, 5 amperes or 10 amperes, the engine actuating assisting current stages.

The current of the charging control circuit 21 is set by the current selection switch 23 so that after charging and conducting, the battery 6 is charged in a constant current. When the charging voltage of the charger has achieve a preset value, it is charged in a constant voltage so that the current is smaller and smaller to become a small current until finally, the power of the charger is cut off. This way may achieve an optimum charging efficiency and the battery 6 is protected. Consequently, the lifetime of the battery 6 is prolonged.

The time period of conduction and non-conduction of the conductive time period control circuit 22 is controllable. In the time period of charging conduction, the battery 6 is charged by a constant current or a small current. As in a non-conduct charging conduction period, it detects the battery 6. When it is detects that the voltage of the battery 6 achieves a voltage of full charging. The power source of the charger is cut off automatically. If it is not achieve a voltage of a set value, then the processes proceed to a next conduction period. The charger charges the battery 6 again.

In order to avoid that in conduction, the battery 6 is overcharged, therefore, as it is charged under a constant current. A high voltage confining circuit 24 outputs a high voltage for confining a small current charging. The input of the high voltage confining circuit 24 is connected to a battery selection switch 25. The battery selection switch 25 serves to select various batteries (water battery, dry battery, etc).

An automatic detection circuit 26 is connected between the input of the charging control circuit 21 and the battery selection switch 25. The automatic detection circuit 26 serves to detect the voltage (such 6 volts or 12 volts) of the battery 6 so as to prevent from a mistake of a 6 volts battery being charged by a 12 volts so as to cause a dangerous condition.

The voltage of battery 6 in full charging and maximum output of the charger are set according to the charging current so as to protect the dump battery 6 is overcharged to cause a dangerous condition and thus the battery 6 is charged substantially.

The second control circuit 3 is connected to a second control switch SW2 and has the functions of detecting the voltage of a battery, output to a control circuit and a polarity protection circuit. The second control circuit 3 is connected to the positive and negative polarities of the battery 6.

1. If the connection of polarities are fault, then the output of the charger will not conduct for preventing the battery 6 and charger from being destroyed.

2. If the voltage of the battery 6 is lower than 5V, it represents that the battery 6 is destroyed and the output of the charger will not conduct for protecting the battery 6 and the charger from danger.

3. When the charger is connected to an AC power source (public power), if it is not connected to a battery 6, the output of the charger is not conducted for preventing from short-circuit so as to induce an explosion.

Besides, in the present invention, the second control circuit 3 is installed with an automatic control circuit and an actuating circuit. When the user knows that the battery 6 is over-discharged so that the voltage is below 5V (due to an over low voltage so as not to actuate a charger). Then, after the charger is connected to the battery 6, this actuating switch is pressed so as to actuate the automatic control circuit to charge the battery 6.

The third control circuit 4 is connected to the first control switch SW1, first control circuit 2 and battery 6. The third control circuit 4 has a power conduction circuit 41, a battery high voltage detecting circuit 42 and a charger output non-conduction control circuit 43. The charger output non-conduction control circuit 43 has an input connected to the conductive time period control circuit 22 of the first control circuit 2. The output of the charger output non-conduction control circuit 43 is connected to the battery high voltage detecting circuit 42. The battery high voltage detecting circuit 42 is connected to the positive and negative polarities of the battery 6. The battery high voltage detecting circuit 42 is connected to a current selection switch 23. The output of the battery high voltage detecting circuit 42 is connected to a power source conduction control wire 41. The power source conduction control wire 41 has an output connected to a first control switch SW1.

The third control circuit 4 detects the voltage of the battery 6 in the distal end of the charging conductive period. If the voltage has achieve a preset full charging voltage then the power is cut off automatically so as to prevent the battery 6 to be over-charged and thus induce an danger. If it is not achieve a set voltage, then the next charging conductive period is entered.

The third control circuit 4 may accurately predict the voltage of the battery 6 (since in the non-conduction period, the voltage has restored to a normal value) so as to prevent the battery 6 to be overcharged. Moreover, during alternation of conduction and non-conduction, the battery 6 is prevented from being overheated due to continuous charging and thus generating gas so as to induce a danger condition.

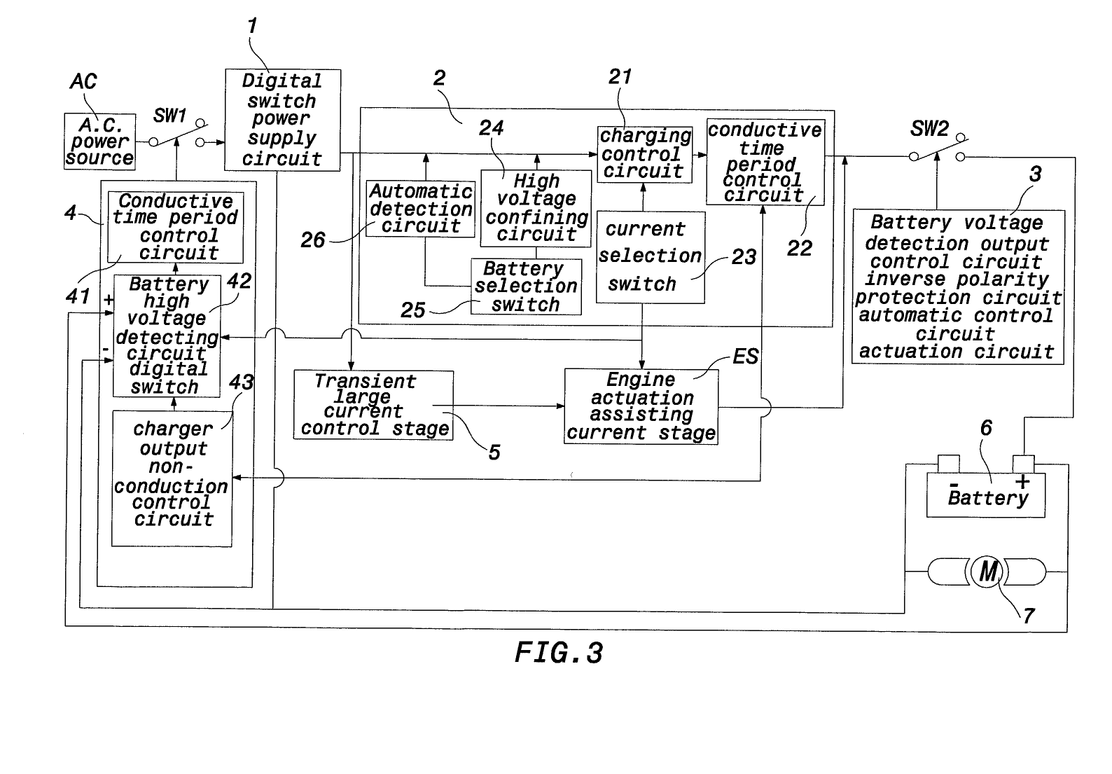

When the current selection switch 23 for charging the current selection switch 23 is adjusted in the engine actuating assisting current stage ES. The charger is separated from the first control circuit 2 and third control circuit 4, a transient large current control wire 5, as shown in FIG. 3. The amount of current can be changed according to the selection of electronic parts, such as 20, 50 or 70 ampere. Thereby, the battery 6 to assist actuation of the car actuating engine, and the charger is protected according to the convenient setting.

Since the size of the car engine is not identical, the actuating current is different. If the setting of the charger is smaller than the practical assisted current. The battery 6 is necessary to charge in a very short time (3˜5 minutes). After the charge of the battery 6 recoveries gradually, the engine is actuated again.

In summary, the special design of the present invention has the following advantages:

1. A switching power rectifier is used in outputting power, thus, it has a stable charged voltage and current, a high efficiency, a compact volume, and is light weighted.

2. The size of charged current is selected and adjustable.

3. In conduction, the battery 6 is charged by a constant current or a small current.

4. The spark does not occur as the charger is in contact with the battery 6.

5. When it is non-conduct in the charging conductive period, the voltage of the battery is detected for measuring a real voltage of the battery.

6. It is be used repeated and many time for assisting a large current to the car engine.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A digital battery charging device comprising:
a digital switch power supply circuit for converting an input A. C. power into digital D. C. power to be outputted for supplying working power of all elements;
a first control switch being connected to an input of a digital switch power supply circuit; wherein as the first control circuit is conductive, an A. C. power is transferred to a digital switch power supply circuit;
a first control circuit installed with a charging control circuit; the first control switch being charged in a constant current or a very smaller current in a constant voltage until a voltage of the battery attains a voltage of being full charged; the charging control circuit having an input connected to an output of the digital switch power supply circuit; an output of the charging control circuit being connected to a conductive time period control circuit; the conductive time period control circuit charging a battery in a charging conduction period, and detecting current in a non-conducting time;
a second control circuit being connected to a second control switch and having functions of detecting the voltage of a battery, outputting signals to a control circuit and protecting the battery as inverse polarity occurs; and
a third control circuit being connected to the first control switch, a conductive time period control circuit of the first control circuit and the battery; wherein the third control circuit detects the voltage of the battery in a distal end of the charging conductive period; if the voltage has achieve a preset full charging voltage; then the first control circuit does not conduct, and the A. C. power is cut off.

2. The digital battery charging device as claimed in claim 1, wherein an output of the digital switch power supply circuit is connected to a transient large current control wire; the transient large current wire functions as a current selection switch is switched to an engine actuation large current assisting stage for achieving the function of assisting the actuation of car engine.

3. The digital battery charging device as claimed in claim 1, wherein the charging control circuit is connected to a current selection switch for selecting and adjusting an amount of charging current.

4. The digital battery charging device as claimed in claim 3, wherein items selectable by the current selection switch includes a 2 ampere, a 5 ampere, a 10 ampere and an engine actuation large current assisting stage.

5. The digital battery charging device as claimed in claim 1, wherein an input of the charging control circuit is connected to a high voltage confining circuit for avoiding an over-current to the battery in a charging conduction period; an input of the high voltage confining circuit is connected to a battery selection switch.

6. The digital battery charging device as claimed in claim 5, wherein an automatic detection circuit is connected between an input of the charging control circuit and battery selection switch for detecting different voltage of the battery.

7. The digital battery charging device as claimed in claim 1, wherein the second control circuit is formed by a battery voltage detecting circuit; a charger output conduction control circuit, an inverse polarity protecting circuit, an automatic control circuit and an actuating switch.

8. The digital battery charging device as claimed in claim 1, wherein the third control circuit is installed with a charger output non-conduction control circuit, an input of the charger output non-conduction control circuit is connected to an conductive time period control circuit; an output of the charger output non-conduction control circuit is connected to a battery high voltage detecting circuit; the battery high voltage detecting circuit is connected to two ends of two polarities of the battery; an input of the battery high voltage detecting circuit is connected to a current selection switch; an output of the battery high voltage detecting circuit is connected to a power source conduction control wire; and an output of the power source conduction control wire is connected to a first control circuit.
